(19) United States
(12) Patent Application Publication
(10) Pub. No.: US 2025/0245605 A1
(43) Pub. Date: Jul. 31, 2025

(54) SYSTEMS AND METHODS FOR OUTBOUND ORDER OPTIMIZATION FOR DETERMINING A TARGET DELIVERY

(71) Applicant: Walmart Apollo, LLC, Bentonville, AR (US)

(72) Inventors: Daniel Alberto Zuniga Vazquez, Tucson, AZ (US); Darshan Rajesh Chauhan, Richardson, TX (US); Zulqarnain Haider, Newark, NJ (US); Yuan Wang, San Francisco, CA (US); Jing Huang, San Jose, CA (US); Mingang Fu, Palo Alto, CA (US); Raghu Ram Moningi, Bangalore (IN); Ishu Jain, Karnal (IN); Nagesh Kopparam, Bangalore (IN); Veena Swaminathan, Bangalore (IN); Sriyansa Sunand Dash, Bengaluru (IN); Sarvesh Kumar Maurya, Bangalore (IN); Sanit Kumar Swain, Bengaluru (IN); Akshay Arora, Bengaluru (IN)

(73) Assignee: Walmart Apollo, LLC, Bentonville, AR (US)

(21) Appl. No.: 18/429,108

(22) Filed: Jan. 31, 2024

(51) Int. Cl. G06Q 10/083; G06Q 10/0631; G06Q 10/1093

(52) U.S. Cl. CPC G06Q 10/083; G06Q 10/06315; G06Q 10/1097

(57) ABSTRACT

Systems and methods including one or more processors and one or more non-transitory storage devices storing computing instructions configured to run on the one or more processors and perform: receiving input information corresponding to allocating one or more containers for delivery from a distribution center to a store during a first time period, the one or more containers including one or more products; processing the input information to determine distribution center constraint information and store constraint information; generating a delivery schedule for the one or more containers from the distribution center to the store over one or more periods of time based on the distribution center constraint information and the store constraint information, wherein each of the one or more periods of time correspond to a day; validating the delivery schedule to determine a target delivery schedule for the one or more containers from the distribution center to the store during the one or more periods of time; and transmitting the target delivery schedule to the distribution center to enable the distribution center to allocate resources to perform the target delivery schedule. Other embodiments are disclosed herein.

### TECHNICAL FIELD

This disclosure relates generally to computing system management, and more particularly to systems and methods for outbound order optimization for determining a target delivery.

### BACKGROUND

Marketplace companies are responsible for millions of products at a time and often provide delivery services related to the millions of products. For example, some marketplace companies provide the delivery of goods to their customers. To deliver goods, the marketplace companies employ delivery systems that include delivery vehicles. The delivery systems may include the scheduling and assignment of delivery orders to delivery vehicles. For example, the marketplace company may coordinate the scheduling and delivery of items from a distribution center to one or more stores. As the number of delivery orders increase, the determination of delivery routes and delivery scheduling, along with delivery costs, may increase as well. As such, there are opportunities to improve delivery systems and to improve delivery scheduling in a goods delivery system.

### BRIEF DESCRIPTION OF THE DRAWINGS

To facilitate further description of the embodiments, the following drawings are provided in which:

FIG. 1 illustrates a front elevational view of a computer system that is suitable for implementing various embodiments of the systems disclosed in FIG. 3;

FIG. 2 illustrates a representative block diagram of an example of the elements included in the circuit boards inside a chassis of the computer system of FIG. 1;

FIG. 3 illustrates a representative block diagram of a system, according to an embodiment;

FIG. 4 illustrates a flowchart for a method, according to certain embodiments;

FIG. 5 illustrates an exemplary outbound order optimizer, according to certain embodiments;

FIG. 6 illustrates an exemplary target optimizer, according to certain embodiments;

FIG. 7 illustrates an exemplary integrated order optimizer, according to certain embodiments;

FIG. 8 illustrates an exemplary alternate target optimizer, according to certain embodiments;

FIG. 9A illustrates exemplary input information, according to certain embodiments; and

FIG. 9B illustrates exemplary output information, according to certain embodiments.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

A number of embodiments can include a system. The system can include one or more processors and one or more non-transitory computer-readable storage devices storing computing instructions. The computing instructions can be configured to run on the one or more processors and cause the one or more processors to perform: receiving input information corresponding to allocating one or more containers for delivery from a distribution center to a store during a first time period, the one or more containers including one or more products; processing the input information to determine distribution center constraint information and store constraint information; generating a delivery schedule for the one or more containers from the distribution center to the store over one or more periods of time based on the distribution center constraint information and the store constraint information, wherein each of the one or more periods of time correspond to a day; validating the delivery schedule to determine a target delivery schedule for the one or more containers from the distribution center to the store during the one or more periods of time; and transmitting the target delivery schedule to the distribution center to enable the distribution center to allocate resources to perform the target delivery schedule.

Various embodiments include a method. The method can be implemented via execution of computing instructions configured to run at one or more processors and configured to be stored at non-transitory computer-readable media. The method can comprise receiving input information corresponding to allocating one or more containers for delivery from a distribution center to a store during a first time period, the one or more containers including one or more products; processing the input information to determine distribution center constraint information and store constraint information; generating a delivery schedule for the one or more containers from the distribution center to the store over one or more periods of time based on the distribution center constraint information and the store constraint information, wherein each of the one or more periods of time correspond to a day; validating the delivery schedule to determine a target delivery schedule for the one or more containers from the distribution center to the store during the one or more periods of time; and transmitting the target delivery schedule to the distribution center to enable the distribution center to allocate resources to perform the target delivery schedule.

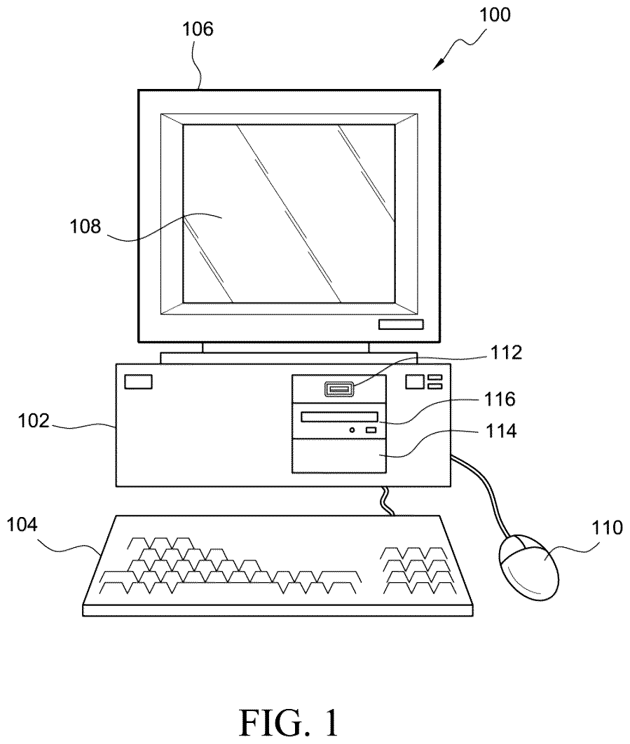

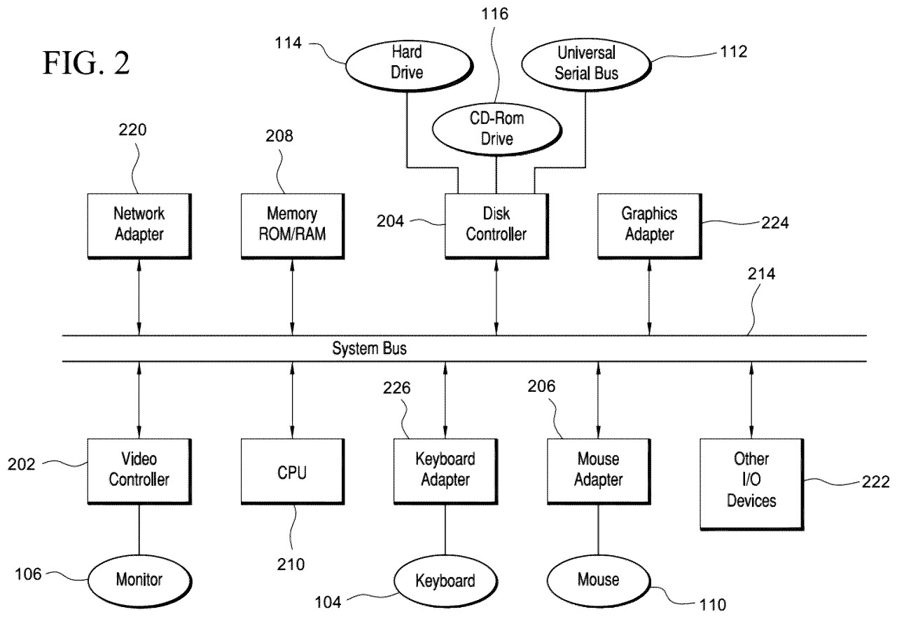

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the memory storage modules described herein. As an example, a different or separate one of a chassis 102 (and its internal components) can be suitable for implementing part or all of one or more embodiments of the techniques, methods, and/or systems described herein. Furthermore, one or more elements of computer system 100 (e.g., a monitor 106, a keyboard 104, and/or a mouse 110, etc.) also can be appropriate for implementing part or all of one or more embodiments of the techniques, methods, and/or systems described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to a memory storage unit 208, where memory storage unit 208 can comprise (i) non-volatile memory, such as, for example, read only memory (ROM) and/or (ii) volatile memory, such as, for example, random access memory (RAM). The non-volatile memory can be removable and/or non-removable non-volatile memory. Meanwhile, RAM can include dynamic RAM (DRAM), static RAM (SRAM), etc. Further, ROM can include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), etc. In these or other embodiments, memory storage unit 208 can comprise (i) non-transitory memory and/or (ii) transitory memory.

In many embodiments, all or a portion of memory storage unit 208 can be referred to as memory storage module(s) and/or memory storage device(s). In various examples, portions of the memory storage module(s) of the various embodiments disclosed herein (e.g., portions of the non-volatile memory storage module(s)) can be encoded with a boot code sequence suitable for restoring computer system 100 (FIG. 1) to a functional state after a system reset. In addition, portions of the memory storage module(s) of the various embodiments disclosed herein (e.g., portions of the non-volatile memory storage module(s)) can comprise microcode such as a Basic Input-Output System (BIOS) operable with computer system 100 (FIG. 1). In the same or different examples, portions of the memory storage module(s) of the various embodiments disclosed herein (e.g., portions of the non-volatile memory storage module(s)) can comprise an operating system, which can be a software program that manages the hardware and software resources of a computer and/or a computer network. The BIOS can initialize and test components of computer system 100 (FIG. 1) and load the operating system. Meanwhile, the operating system can perform basic tasks such as, for example, controlling and allocating memory, prioritizing the processing of instructions, controlling input and output devices, facilitating networking, and managing files. Exemplary operating systems can comprise one of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further exemplary operating systems can comprise one of the following: (i) the iOS® operating system by Apple Inc. of Cupertino, California, United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processing modules of the various embodiments disclosed herein can comprise CPU 210.

Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs. In many embodiments, an application specific integrated circuit (ASIC) can comprise one or more processors or microprocessors and/or memory blocks or memory storage.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to keyboard 104 (FIGS. 1-2) and mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM drive 116 (FIGS. 1-2). In other embodiments, distinct units can be used to control each of these devices separately.

Network adapter 220 can be suitable to connect computer system 100 (FIG. 1) to a computer network by wired communication (e.g., a wired network adapter) and/or wireless communication (e.g., a wireless network adapter). In some embodiments, network adapter 220 can be plugged or coupled to an expansion port (not shown) in computer system 100 (FIG. 1). In other embodiments, network adapter 220 can be built into computer system 100 (FIG. 1). For example, network adapter 220 can be built into computer system 100 (FIG. 1) by being integrated into the motherboard chipset (not shown), or implemented via one or more dedicated communication chips (not shown), connected through a PCI (peripheral component interconnector) or a PCI express bus of computer system 100 (FIG. 1) or USB port 112 (FIG. 1).

Returning now to FIG. 1, although many other components of computer system 100 are not shown, such components and their interconnection are well known to those of ordinary skill in the art. Accordingly, further details concerning the construction and composition of computer system 100 and the circuit boards inside chassis 102 are not discussed herein.

Meanwhile, when computer system 100 is running, program instructions (e.g., computer instructions) stored on one or more of the memory storage module(s) of the various embodiments disclosed herein can be executed by CPU 210 (FIG. 2). At least a portion of the program instructions, stored on these devices, can be suitable for carrying out at least part of the techniques and methods described herein.

Further, although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile electronic device, such as a smartphone. In certain additional embodiments, computer system 100 may comprise an embedded system.

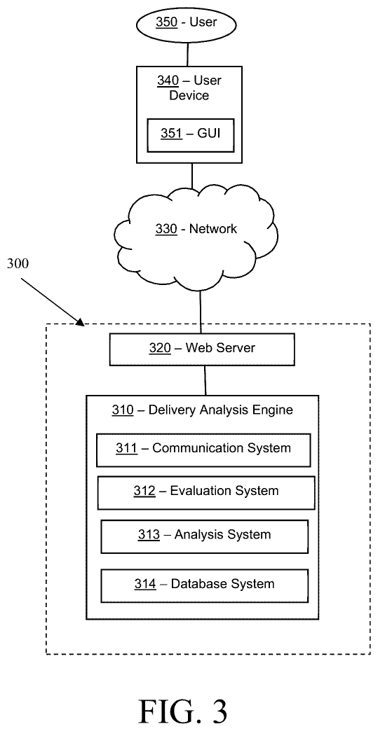

Turning ahead in the drawings, FIG. 3 illustrates a block diagram of a system 300 that can be employed for target delivery analysis, according to an embodiment. System 300 is merely exemplary and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300. In some embodiments, system 300 can include a delivery analysis engine 310 and/or web server 320.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

Delivery analysis engine 310 and/or web server 320 can each be a computer system, such as computer system 100 (FIG. 1), as described above, and can each be a single computer, a single server, or a cluster or collection of computers or servers, or a cloud of computers or servers. In another embodiment, a single computer system can host delivery analysis engine 310 and/or web server 320. Additional details regarding delivery analysis engine 310 and/or web server 320 are described herein.

In some embodiments, web server 320 can be in data communication through a network 330 with one or more user devices, such as a user device 340, which also can be part of system 300 in various embodiments. User device 340 can be part of system 300 or external to system 300. Network 330 can be the Internet or another suitable network. In some embodiments, user device 340 can be used by users, such as a user 350. In many embodiments, web server 320 can host one or more websites and/or mobile application servers. For example, web server 320 can host a website, or provide a server that interfaces with an application (e.g., a mobile application), on user device 340, which can allow users (e.g., 350) to interact with delivery analysis engine 310, in addition to other suitable activities. In a number of embodiments, web server 320 can interface with delivery analysis engine 310 when a user (e.g., 350) is viewing infrastructure components in order to assist with the analysis of the infrastructure components corresponding to target delivery of items.

In some embodiments, an internal network that is not open to the public can be used for communications between delivery analysis engine 310 and web server 320 within system 300. Accordingly, in some embodiments, delivery analysis engine 310 (and/or the software used by such systems) can refer to a back end of system 300 operated by an operator and/or administrator of system 300, and web server 320 (and/or the software used by such systems) can refer to a front end of system 300, as is can be accessed and/or used by one or more users, such as user 350, using user device 340. In these or other embodiments, the operator and/or administrator of system 300 can manage system 300, the processor(s) of system 300, and/or the memory storage unit(s) of system 300 using the input device(s) and/or display device(s) of system 300.

In certain embodiments, the user devices (e.g., user device 340) can be desktop computers, laptop computers, mobile devices, and/or other endpoint devices used by one or more users (e.g., user 350). A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Further still, the term “wearable user computer device” as used herein can refer to an electronic device with the capability to present audio and/or visual data (e.g., text, images, videos, music, etc.) that is configured to be worn by a user and/or mountable (e.g., fixed) on the user of the wearable user computer device (e.g., sometimes under or over clothing; and/or sometimes integrated with and/or as clothing and/or another accessory, such as, for example, a hat, eyeglasses, a wrist watch, shoes, etc.). In many examples, a wearable user computer device can comprise a mobile electronic device, and vice versa. However, a wearable user computer device does not necessarily comprise a mobile electronic device, and vice versa.

In specific examples, a wearable user computer device can comprise a head mountable wearable user computer device (e.g., one or more head mountable displays, one or more eyeglasses, one or more contact lenses, one or more retinal displays, etc.) or a limb mountable wearable user computer device (e.g., a smart watch). In these examples, a head mountable wearable user computer device can be mountable in close proximity to one or both eyes of a user of the head mountable wearable user computer device and/or vectored in alignment with a field of view of the user.

In more specific examples, a head mountable wearable user computer device can comprise (i) Google Glass™ product or a similar product by Google Inc. of Menlo Park, California, United States of America; (ii) the Eye Tap™ product, the Laser Eye Tap™ product, or a similar product by ePI Lab of Toronto, Ontario, Canada, and/or (iii) the Raptyr™ product, the STAR 1200™ product, the Vuzix Smart Glasses M100™ product, or a similar product by Vuzix Corporation of Rochester, New York, United States of America. In other specific examples, a head mountable wearable user computer device can comprise the Virtual Retinal Display™ product, or similar product by the University of Washington of Seattle, Washington, United States of America. Meanwhile, in further specific examples, a limb mountable wearable user computer device can comprise the iWatch™ product, or similar product by Apple Inc. of Cupertino, California, United States of America, the Galaxy Gear or similar product of Samsung Group of Samsung Town, Seoul, South Korea, the Moto 360 product or similar product of Motorola of Schaumburg, Illinois, United States of America, and/or the Zip™ product, One™ product, Flex™ product, Charge™ product, Surge™ product, or similar product by Fitbit Inc. of San Francisco, California, United States of America.

Exemplary mobile devices can include (i) an iPod®, iPhone®, iTouch®, iPad®, MacBook® or similar product by Apple Inc. of Cupertino, California, United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, (ii) the Blackberry® operating system by Research In Motion (RIM) of Waterloo, Ontario, Canada, (iii) the Android™ operating system developed by the Open Handset Alliance, or (iv) the Windows Mobile™ operating system by Microsoft Corp. of Redmond, Washington, United States of America.

In many embodiments, delivery analysis engine 310 and/or web server 320 can each include one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to delivery analysis engine 310 and/or web server 320 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of delivery analysis engine 310 and/or web server 320. In a similar manner, the processors and/or the non-transitory computer-readable media can be local and/or remote to each other.

Meanwhile, in many embodiments, delivery analysis engine 310 and/or web server 320 also can be configured to communicate with one or more databases, such as a database system 314. The one or more databases can include delivery information, and/or machine learning training data, for example, among other data as described herein. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, delivery analysis engine 310, web server 320, and/or the one or more databases can be implemented using any suitable manner of wired and/or wireless communication. Accordingly, system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, delivery analysis engine 310 can include a communication system 311, an evaluation system 312, an analysis system 313, and/or database system 314. In many embodiments, the systems of delivery analysis engine 310 can be modules of computing instructions (e.g., software modules) stored at non-transitory computer readable media that operate on one or more processors. In other embodiments, the systems of delivery analysis engine 310 can be implemented in hardware. delivery analysis engine 310 and/or web server 320 each can be a computer system, such as computer system 100 (FIG. 1), as described above, and can be a single computer, a single server, or a cluster or collection of computers or servers, or a cloud of computers or servers. In another embodiment, a single computer system can host delivery analysis engine 310 and/or web server 320. Additional details regarding delivery analysis engine 310 and the components thereof are described herein.

In many embodiments, user device 340 can comprise graphical user interface (“GUI”) 351. In the same or different embodiments, GUI 351 can be part of and/or displayed by user device 340, which also can be part of system 300. In some embodiments, GUI 351 can comprise text and/or graphics (image) based user interfaces. In the same or different embodiments, GUI 351 can comprise a heads up display (“HUD”). When GUI 351 comprises a HUD, GUI 351 can be projected onto a medium (e.g., glass, plastic, etc.), displayed in midair as a hologram, or displayed on a display (e.g., monitor 106 (FIG. 1)). In various embodiments, GUI 351 can be color, black and white, and/or greyscale. In many embodiments, GUI 351 can comprise an application running on a computer system, such as computer system 100 (FIG. 1), user device 340. In the same or different embodiments, GUI 351 can comprise a website accessed through network 330. In some embodiments, GUI 351 can comprise an eCommerce website. In these or other embodiments, GUI 351 can comprise an administrative (e.g., back end) GUI allowing an administrator to modify and/or change one or more settings in system 300. In the same or different embodiments, GUI 351 can be displayed as or on a virtual reality (VR) and/or augmented reality (AR) system or display. In some embodiments, an interaction with a GUI can comprise a click, a look, a selection, a grab, a view, a purchase, a bid, a swipe, a pinch, a reverse pinch, etc.

In some embodiments, web server 320 can be in data communication through network (e.g., Internet) 330 with user computers (e.g., 340). In certain embodiments, user devices 340 can be desktop computers, laptop computers, smart phones, tablet devices, and/or other endpoint devices. Web server 320 can host one or more websites. For example, web server 320 can host an eCommerce website that allows users to browse and/or search for products, to add products to an electronic shopping cart, and/or to purchase products, in addition to other suitable activities.

In many embodiments, delivery analysis engine 310, and/or web server 320 can be configured to communicate with one or more user devices 340. In some embodiments, user devices 340 also can be referred to as customer computers. In some embodiments, delivery analysis engine 310, and/or web server 320 can communicate or interface (e.g., interact) with one or more customer computers (such as user devices 340) through a network 330. Network 330 can be an intranet that is not open to the public. In further embodiments, network 330 can be a mesh network of individual systems. Accordingly, in many embodiments, delivery analysis engine 310, and/or web server 320 (and/or the software used by such systems) can refer to a back end of system 300 operated by an operator and/or administrator of system 300, and user device 340 (and/or the software used by such systems) can refer to a front end of system 300 used by one or more users 350, respectively. In some embodiments, users 350 can also be referred to as customers, in which case, user device 340 can be referred to as customer computers. In these or other embodiments, the operator and/or administrator of system 300 can manage system 300, the processing module(s) of system 300, and/or the memory storage module(s) of system 300 using the input device(s) and/or display device(s) of system 300.

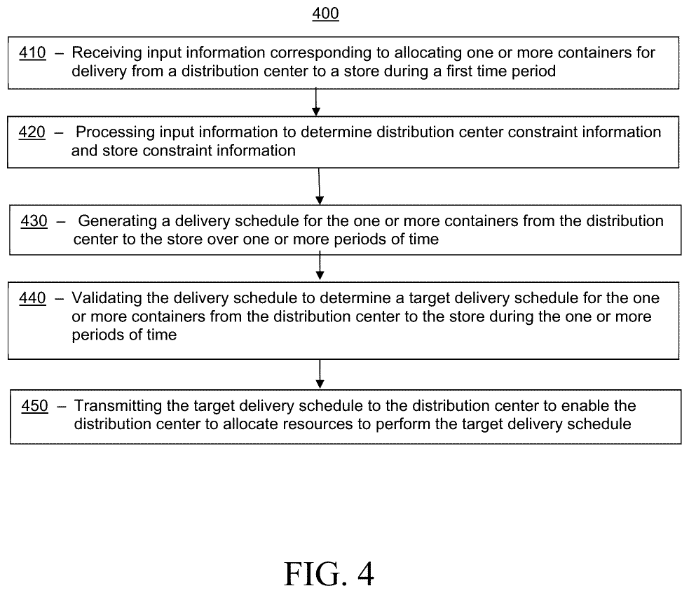

Turning ahead in the drawings, FIG. 4 illustrates a flow chart for a method 400, according to an embodiment. Method 400 is merely exemplary and is not limited to the embodiments presented herein. Method 400 can be employed in many different embodiments or examples not specifically depicted or described herein. In some embodiments, the activities of method 400 can be performed in the order presented. In other embodiments, the activities of method 400 can be performed in any suitable order. In still other embodiments, one or more of the activities of method 400 can be combined or skipped. In many embodiments, system 300 (FIG. 3) can be suitable to perform method 400 and/or one or more of the activities of method 400. In these or other embodiments, one or more of the activities of method 400 can be implemented as one or more computer instructions configured to run at one or more processing modules and configured to be stored at one or more non-transitory memory storage modules. Such non-transitory memory storage modules can be part of a computer system such as delivery analysis engine 310, web server 320, and/or user device 340 (FIG. 3). The processing module(s) can be similar or identical to the processing module(s) described above with respect to computer system 100 (FIG. 1).

In many embodiments, method 400 can comprise an activity 410 of receiving input information corresponding to allocating one or more containers for delivery from a distribution center to a store during a first time period. In some embodiments, the container can be a pallet including (a) one or more boxes containing products, or (b) a box containing products. In some embodiments, the one or more containers include one or more products. In some embodiments, the input information includes configuration information, container information, store information, and distribution center information. For example, the input information can include distribution center information (e.g., loading/unloading constraints, inventory constraints, etc.), store information (e.g., item inventory requirements and constraints, etc.), and capping/pull-forward information (e.g., the ability of the distribution center to increase/delay item deliveries).

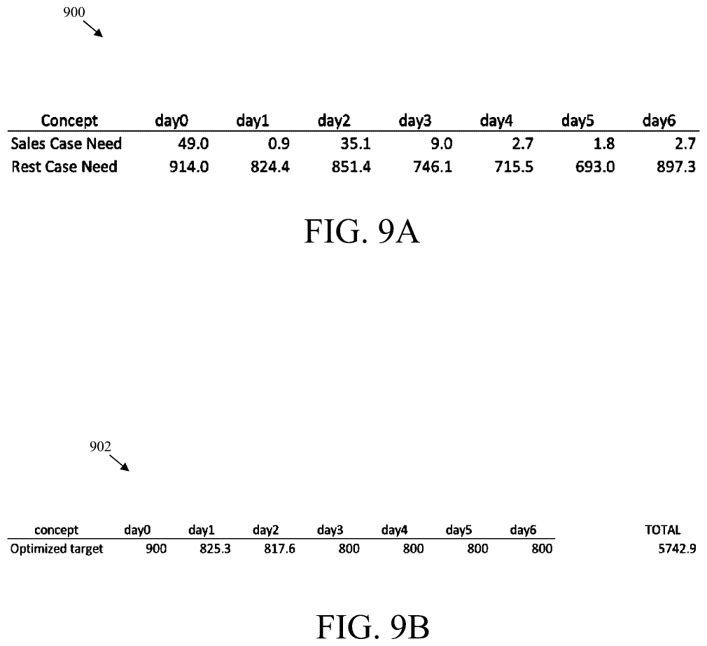

Turning briefly to FIG. 9A, exemplary input information 900 is illustrated. In the illustrated embodiment, the input information 900 corresponds to containers for a store, and can include the additional constraints: a minimum case range of 800, a maximum case range of 900, labor capacity of 80,000, and a smoothing horizon of 7 days (e.g., the one or more containers are to be modified within a 7 day period).

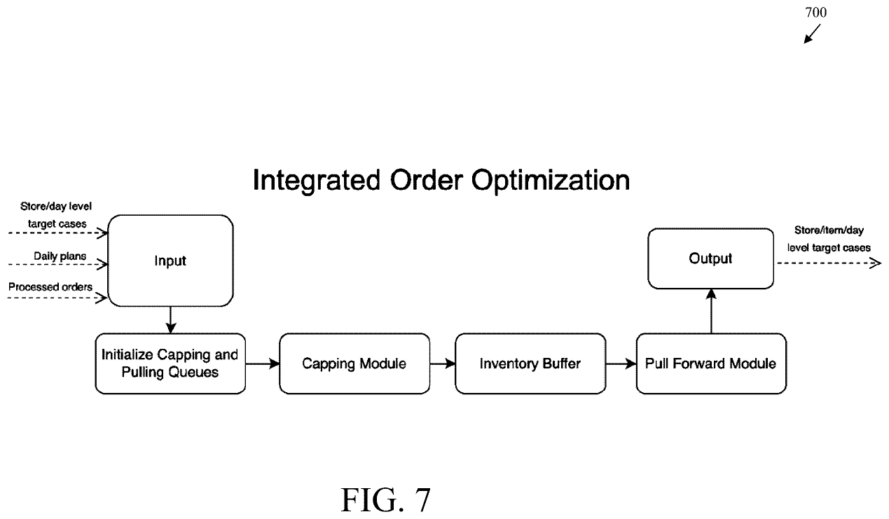

Returning to FIG. 4, in many embodiments, method 400 can comprise an activity 420 of processing the input information to determine distribution center constraint information and store constraint information. In some embodiments, processing the input information to determine the distribution center constraint information and the store constraint information further comprises analyzing the distribution center information to determine a distribution center capacity measurement. In some embodiments, the distribution center capacity measurement includes determining labor capacity for each of the one or more periods of time. For example, the one or more periods of time correspond to a 24 hour period and the labor capacity is determined for each 24 hour period. In some embodiments, the distribution center capacity measurement includes determining inventory constraints of the distribution center. For example, the inventory constraints corresponds to how much of product is available for delivery during the one or more periods of time. In some embodiments, the distribution center capacity measurement includes determining capping information and pull-forward information for the distribution center. In some embodiments, the capping information and the pull-forward information correspond to an ability of the distribution center to decrease or increase delivery of the one or more containers. For example, pull-forward information corresponds to a number of products that can be delivered earlier than originally scheduled. The capping information and the pull-forward information is discussed in more detail below in connection with FIG. 7.

In some embodiments, processing the input information to determine the distribution center constraint information and the store constraint information further comprises analyzing the store constraint information to determine a store requirement measurement. In some embodiments, the store requirement measurement corresponds to a minimum requirement value and a maximum requirement value. For example, a minimum amount of a product and a maximum amount of the product.

In many embodiments, method 400 can comprise an activity 430 of generating a delivery schedule for the one or more containers from the distribution center to the store over one or more periods of time. In some embodiments, a delivery schedule corresponds to determining a target number of delivery cases. For example, a delivery schedule can correspond to determining a schedule of a quantity of delivery cases to be delivered each day. In some embodiments, the delivery schedule is based on the distribution center constraint information and the store constraint information. In some embodiments, each of the one or more periods of time correspond to a day, and the first period of time can correspond to a 7 day period. For example, activity 430 analyzes specific orders from the stores and the input information to generate daily delivery plans for the week. In some embodiments, the delivery schedule is determined using a target optimizer.

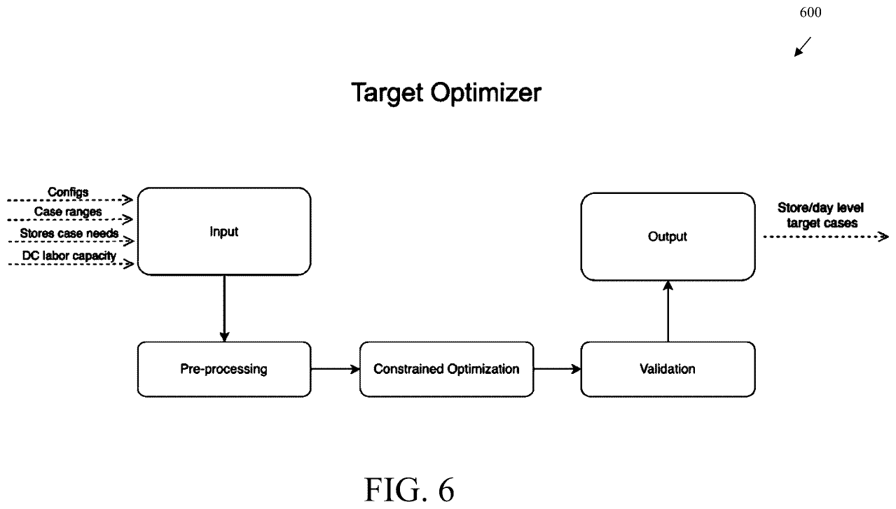

Turning to FIG. 6, and exemplary target optimizer 600 is illustrated, according to an embodiment. Target optimizer 600 can be used to implement activity 430 (FIG. 4). In the illustrated embodiment, the target optimizer receives the input information and any additional constraint information. As an example, the input information can include configuration input such as distribution center type, smoothening days, store ids, and also can include case ranges such as minimum case range, which indicates a lower bound for the amount of cases that can be allocated per store (e.g., for store id=001 and 7 smoothening days a minimum case range can be [950, 950, 950, 900, 900, 850, 950]) and maximum case range, which indicates an upper bound for the amount of cases that can be allocated per store (e.g., for store id=001 and 7 smoothening days a maximum case range can be [1200, 1200, 1250, 1200, 1150, 1200, 1250]). In the same or different examples, the input information can further include the case needs of one or more stores and the labor capacity of a distribution center. In some embodiments, the target optimizer performs a pre-processing analysis on the input information. In some embodiments, the pre-processing analysis includes the following: (1) check sum of store sale needs against distribution center capacity, and adjust the allocation; (2): determine store minimum cases accounting for adjusted sale need; and (3) determine minimum range breach by comparing store min-max range with distribution center capacity.

In some embodiments, the target optimizer performs a constrained optimization analysis on the input information. In some embodiments, the constrained optimization analysis includes the following: (4): perform a labor-unconstrained target optimization analysis to find store level target cases, given the min-max case range, while ignoring distribution center capacity constraints; (5): perform a target optimization analysis that is constrained by the distribution center capacity on Day 0 of the period of time (e.g., period of time is a 7 day period), while minimizing a capping variance for Day 0 and respecting the min-max case range; and (6): perform a fully labor constrained target optimization analysis, while minimizing a pull forward variance for Day 0 and respecting the min-max case range.

In some embodiments, the target optimizer performs a validation analysis by validating that the target delivery for each day satisfies the min-max case range for the store and the distribution center capacity constraints. In some embodiments, the validation analysis includes validating the target delivery for each day based on the capping information and the pull-forward information, as discussed in more detail below. The target optimizer then generates an output that includes the store and day level target containers to be delivered.

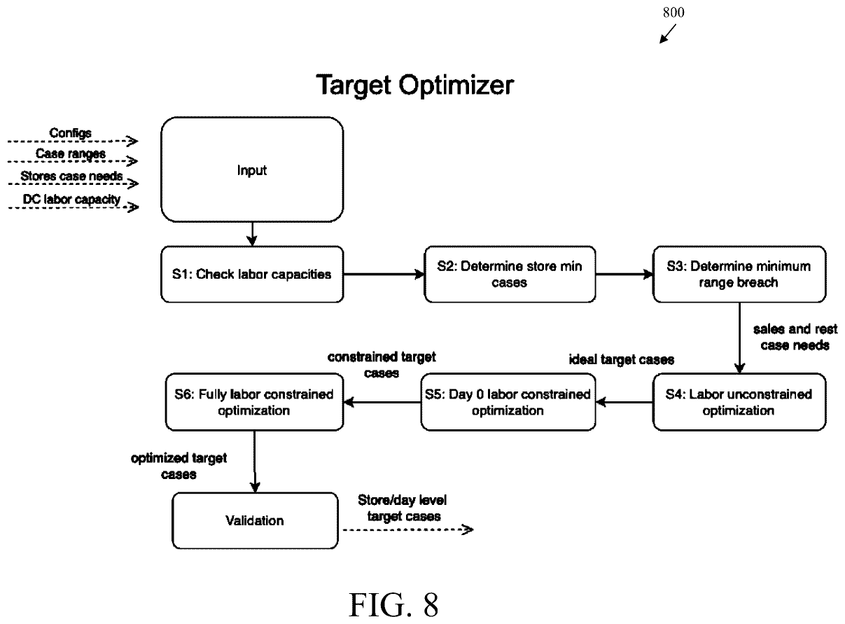

FIG. 8 illustrates an alternate target optimizer 800 that can be utilized to implement activity 430 (FIG. 4). The alternate target optimizer 800 operates in a similar manner as the target optimizer 600 (FIG. 6). However, the alternate target optimizer 800 includes separate modules for each function of the target optimizer 600 (FIG. 6). As an example, the pre-processing analysis in FIG. 6 can correspond to modules S1, S2, and S3 in FIG. 8. Similarly, the constrained optimization analysis in FIG. 6 can correspond to modules S4, S5, and S6 in FIG. 8.

Turning to FIG. 9B, an example output 902 of the target optimizer 600 (FIG. 6) and/or the alternate target optimizer 800 (FIG. 8) is illustrated based on the input information 900 (FIG. 9A). The output 902 is the result of the analysis performed by the target optimizer 600 (FIG. 6) and/or the alternate target optimizer 800 (FIG. 8) based on the input information 900 (FIG. 9A).

Returning to FIG. 4, in many embodiments, method 400 can comprise an activity 440 of validating the delivery schedule to determine a target delivery schedule for the one or more containers from the distribution center to the store during the one or more periods of time. In some embodiments, validating the delivery schedule to determine the target delivery schedule for the one or more containers from the distribution center to the store during the one or more periods of time further comprises comparing the delivery schedule with capping information and pull-forward information for the distribution center to ensure the distribution center has enough resources to perform the delivery schedule. The capping information and pull-forward information are discussed below in connection with FIG. 7.

In many embodiments, method 400 can comprise an activity 450 of transmitting the target delivery schedule to the distribution center to enable the distribution center to allocate resources to perform the target delivery schedule.

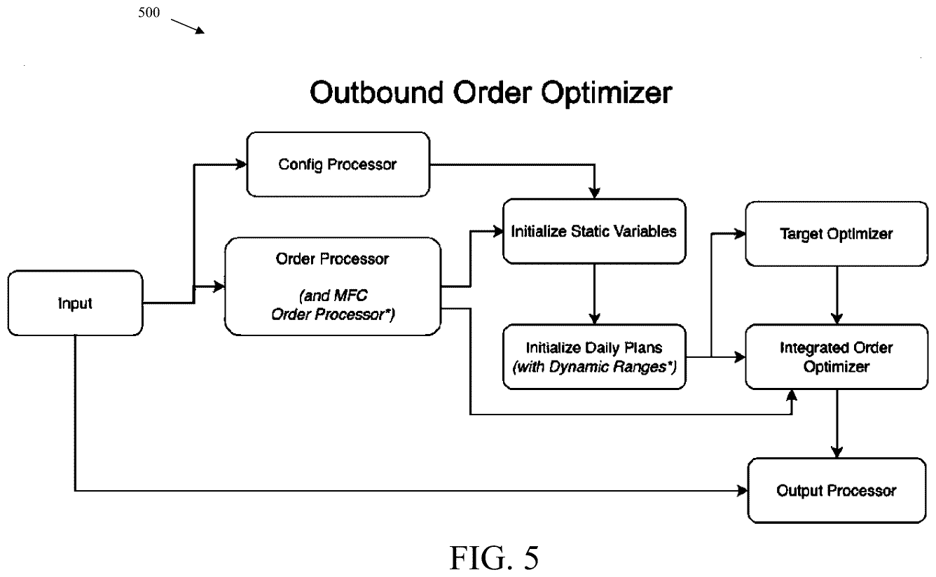

Turning to FIG. 5, an outbound order optimizer 500 is illustrated that can determine a target delivery schedule according to embodiments disclosed herein. In the illustrated embodiment, the outbound optimizer 500 receives input information.

The outbound order optimizer 500 includes a configuration processor that analyzes vehicle configurations based on quantities, weight, volume, and intercept of one or more vehicles. In some embodiments, the configuration processor determines a case to pallet conversion to assist with determining loading information for a vehicle. In some embodiments, the configuration processor processes missing store configuration values such as minimum and maximum case ranges.

The outbound order optimizer 500 includes an order processor. In some embodiments, the order processor performs one or more of the following: extracts orders from a data frame, extracts columns from a data frame, processes null values, processes cumulative values, processes minimum shipment quantities, updates columns and data types, filters zero needs forecasts orders, handles NaN values for shelf capacities, updates future forecast for delivery order dates.

In some embodiments, the outbound order optimizer 500 initializes static variables. In some embodiments, initializing the static variables can include initializing: minimum shipment quantity, trailer max weight, etc.

In some embodiments, the outbound order optimizer 500 initializes daily plans. In some embodiments, initializing the daily plans can include: generating a daily plan for each day of the time period, and transmitting the processed information to the target optimizer (e.g., target optimizer 600 (FIG. 6), alternate target optimizer 800 (FIG. 8)) and the integrated order optimizer 700 (FIG. 7). The output is generated by the integrated order optimizer 700 (FIG. 7), as discussed in more detail below.

Turning to FIG. 7, the integrated order optimizer 700 is illustrated according to certain embodiments. In some embodiments, the integrated order optimizer 700 receives the target delivery schedule from the target optimizer 600 (FIG. 6) and determines a daily schedule for the distribution center based on the target delivery schedule. In some embodiments, the integrated order optimizer 700 receives a listing of orders that have been processed. For example, if orders have been processed the integrated order optimizer 700 can remove the orders from the target delivery schedule. In the same or different example, integrated order optimizer 700 can receive additional input, such as the target level of cases for a store or a day, the daily plans, and processed orders.

In some embodiments, the integrated order optimizer 700 determines if the store is a capping store, a pull forward store, or a skip store based on the daily schedule for the distribution center. As an example, a capping store can be identified if its Day 0 level target cases (e.g., 700 cases) is greater than its Day 0 target cases (e.g., 600) and its store skip flag is set to skip none; a pull forward store can be identified if its Day 0 level target cases (e.g., 700 cases) is smaller than its Day 0 target cases (e.g., 800) and its store skip flag is set to skip none; and a skip store can be identified as a store set with a skip flag, e.g. skip capping, skip pull forward, skip all. In some embodiments, if the store is determined to be a capping store, the integrated order optimizer 700 analyzes the item level listing of the capping items for the daily schedule to determine a number of items that are to be removed from the daily schedule. A store can be determined to be a capping store when its Day 0 coverage period need is greater than its store/Day 0 level target cases solution from Target Optimizer FIG. 6. In some embodiments, if the store is determined to be a pull-forward store, the integrated order optimizer 700 analyzes the item level listing of the pull-forward items for the daily schedule to determine a number of items that are to be added to the daily schedule. A store can be determined to be a pull forward store when Day 0 coverage period need is smaller than its store/Day 0 level target cases solution from Target Optimizer FIG. 6. In some embodiments, the integrated order optimizer 700 generates an item level listing of capping items and pull forward items based on a decision ratio. In some embodiments, the decision ration is determined based on a ratio of target items for a store, minimum number of items for a store, maximum number of items for a store, distribution center capacity constraints, and store constraints. In some embodiments, if the store is determined to be a skip store, the integrated order optimizer 700 can skip capping or pull forward according to the skip flag of the store, e.g., a store with skip capping flag will not be capped, a store with skip pull forward flag will not be pulled forward, a store with skill all flag will not be capped or pull forward.

In the illustrated embodiment, the integrated order optimizer 700 includes a capping module.

In some embodiments, the capping module includes the following algorithm:
1. While the capping queue is not empty
   1.1. Retrieve the order with the best decision ratio
   1.2. Perform the capping checks to identify if the order is a valid candidate for capping (explained next slide)
   1.3. If ALL checks are passed:
      1.3.1. Capping is performed based on the incremental shipment quantity
      1.3.2. Information is updated:
         1.3.2.1. Daily plan
         1.3.2.2. Incremental shipment quantity (updated against minimum shipment quantity)
         1.3.2.3. Captures log for trailer rounding (if Day0 discounted total cases<=target cases, where discounted total cases is total need cases times a multiplier)
         1.3.2.4. DC onhands (inventory available)
         1.3.2.5. DC labor available
         1.3.2.6. Saves information of last capped order
         1.3.2.7. Updates/recalculates decision ratio for the order and adds it to the capping heap list
   1.4. Else:
      1.4.1. Item is discarded from the heap list, and no capping is performed

In the illustrated embodiment, the capping module can generate an output data frame that includes one or more messages. In some embodiments, the messages with the following considerations: (1) any message means that an item was not able to successfully be capped or pulled forward and there is a valid reason for it; (2) an item may have multiple reason for not capping/pull forward, but only the first check that fails is allocated to the data frame; and (3) an item allocated quantity may be capped/pull forward multiple times successfully and a check fails on the Nth time, the data frame will be populated with the failed reason.

In some embodiments, the data frame can include one or more of the following:
1. (GDC,RDC) “CAPPING: ITEM_MIN_QTY_SHIPPED”: when allocated quantity-increment quantity is <minimum shipment quantity. (this message only applies when use_capping_min_qty_cnstr=True)
2. (GDC,RDC) “CAPPING: ITEM_NOT_SHIPPED”: when allocated quantity-increment quantity is <0. (if use_capping_min_qty_cnstr=False, then this message is used)
3. (GDC) “CAPPING: STORE_PALLETS_REACHING_TRAILER_MAX”: this message is triggered if the number of pallets is close to the trailer max pallets even though we are below trailer max weight and below case range max
4. (RDC) “CAPPING: STORE_GROUP_TYPE_CAPPING_COUNTER_REACHED”: each group has its individual counter of how much it can be capped based on the optimized target solution. This message is triggered when the counter is already reached.
5. (RDC) “CAPPING: STORE_BELOW_TARGET_BY_GROUP_TYPE”: used when total discounted cases of a group<target cases for that group
6. (GDC,RDC) “CAPPING: STORE_BELOW_TARGET”: used when total discounted cases<target cases

In one example embodiment for the capping module, an item with a minimum decision ratio objective is selected (e.g. −6.487). In this embodiment, the item currently has 4 cases allocated with a minimum and incremental quantity of 1 case. Capping checks are performed (e.g., store target cases, trailer weight, maximum pallet capacity, minimum case quantity, etc.), and all checks are passed and the item is successfully capped. The information of the item is updated (e.g., allocated cases, incremental quantity, labor availability, inventory availability, trailer weight, number of pallets, etc.), and a new decision ratio is calculated (e.g., −2.395).

In the illustrated embodiment, the integrated order optimizer 700 includes an inventory buffer. The inventory buffer operates if at least one pull forward store is identified. In some embodiments, the inventory buffer includes the following activities: (1) The maximum pull forward period of time is identified from all the pull forward stores of a distribution center (DC); (2) Orders from stores not identified as pull forward are set as buffer orders; (3) The stores smoothening period need is sum from Day0 to the pull forward period of time (store/item); (4) The sum is grouped by item; (5) This sum is defined as the inventory buffer, i.e., the total needs over max pull forward period of time.

In the illustrated embodiment, the integrated order optimizer 700 includes a pull-forward module.

In some embodiments, the pull-forward module includes the following algorithm:
1. While the pull forward queue is not empty
   1.1. Retrieve the order with the best decision ratio
   1.2. Perform the capping checks to identify if the order is a valid candidate for pull forward (explained next slide)
   1.3. If all checks are passed:
      1.3.1. Pull forward is performed based on the incremental shipment quantity
      1.3.2. Information is updated:
         1.3.2.1. Daily plan
         1.3.2.2. Incremental shipment quantity (updated against minimum shipment quantity)
         1.3.2.3. DC onhands (inventory available)
         1.3.2.4. DC labor available
         1.3.2.5. Saves information of last pull forward order
         1.3.2.6. Updates/recalculates decision ratio for the order and adds it to the pull forward heap list
   1.4. Else:
      1.4.1. Item is discarded from the heap list and no pull forward is performed

In some embodiments, the data frame for the pull-forward module can include one or more of the following:
1. (GDC,RDC) “PF: ITEM_SKIPPED_FOR_PF”: This message is allocated for items with “SKIP_PULL_FORWARD”
2. (GDC,RDC) “PF: ONHANDS_EQUAL_BUFFER”: if dc onhands<=item buffer
3. (GDC,RDC) “PF: INV_NOT_ENOUGH”: if dc onhands—item buffer<increment quantity
4. (GDC,RDC) “PF: NO_PF_DAY_ELIGIBLE”: if there is no future day eligible
5. (GDC,RDC) “PF: NO_AVAILABLE_LABOR_GROUP_TYPE”: if there is no available labor for that group
6. (GDC,RDC) “PF: MAX_DOS_REACHED”: if days of supply is not compliant
7. (GDC,RDC) “PF: SHELF_CAP_AND_DOS_BREACHED”: if both constraints, shelf capacity and days of supply breached are violated
8. (GDC,RDC) “PF: STORE_CAPPED”: if store is capped
9. (GDC) “PF: STORE_PALLETS_REACHING_TRAILER_MAX”: if number of pallets is reaching the max trailer pallets
10. (RDC) “PF: STORE_GROUP_TYPE_PF_COUNTER_REACHED”: each group has its individual counter of how much it can be pulled forward based on the optimized target solution. This message is triggered when the counter is already reached.

In one example embodiment for the pull-forward module, an item with a minimum decision ratio from the pull-forward list is selected (e.g. −0.685). The item currently has 2 cases allocated with a min. and incremental quantity of 1 case. Pull-forward checks are performed (e.g., labor availability, inventory availability, inventory buffer, pull forward day eligible, max DOS, shelf capacity, trailer weight, max number pallets, store target cases, etc.). All checks are passed and the item is successfully pulled forward. The information of the item is updated (e.g., allocated cases, incremental quantity, labor availability, inventory availability, trailer weight, number of pallets, etc.), and its new decision ratio is calculated (e.g., 0.132) and it is added to the pull-forward listing.

In some embodiments, the output of the integrated order optimizer 700 updates the target delivery schedule based on the item level listing of the capping items and the pull forward items to allocate resources to perform the target delivery schedule.

Returning to FIG. 3, in several embodiments, communication system 311 can at least partially perform activity 410 (FIG. 4), and/or activity 450 (FIG. 4).

In several embodiments, evaluation system 312 can at least partially perform activity 420 (FIG. 4).

In a number of embodiments, analysis system 313 can at least partially perform activity 430 (FIG. 4), and/or activity 440 (FIG. 4).

In a number of embodiments, web server 320 can at least partially perform method 400.

Although systems and methods for determining a target delivery schedule have been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-9B may be modified, and that the foregoing discussion of certain of these embodiments does not necessarily represent a complete description of all possible embodiments. For example, one or more of the procedures, processes, or activities of FIG. 4 may include different procedures, processes, and/or activities and be performed by many different modules, in many different orders.

Current delivery scheduling systems create variability for stores in terms of unpredictable goods volume and delivery schedules. As a result, store operations struggle to plan labor and store associates find it challenging to unload and stock within scheduled hours.

Embodiments disclosed herein are directed to redistributing item cases that are shipped between distribution centers and stores. For example, embodiments disclosed herein analyze the anticipated shipping schedule for particular items and optimizes the shipping schedule for those items to mitigate bottlenecks at the distribution center and ensure that adequate resources are available to deliver the items to the stores. This reduction in variability results in a consistent volume of goods delivered daily to the stores, facilitating labor planning and mitigating previous issues, thereby resulting in an improvement to the technical field of delivery scheduling.

Embodiments disclosed herein a incorporate Network Constraints to ensure that case orders are consistent with the available labor of a distribution center.

Embodiments disclosed herein also have faster response time compared to previous solutions. For example, embodiments disclosed herein generate outputs in less than 100 milliseconds per distribution center per store.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

1. A system comprising:
one or more processors; and
one or more non-transitory computer-readable media storing computing instructions that, when run on the one or more processors, cause the one or more processors to perform:
receiving input information corresponding to allocating one or more containers for delivery from a distribution center to a store during a first time period, the one or more containers including one or more products;
processing the input information to determine distribution center constraint information and store constraint information;
generating a delivery schedule for the one or more containers from the distribution center to the store over one or more periods of time based on the distribution center constraint information and the store constraint information, wherein each of the one or more periods of time correspond to a day;
validating the delivery schedule to determine a target delivery schedule for the one or more containers from the distribution center to the store during the one or more periods of time; and
transmitting the target delivery schedule to the distribution center to enable the distribution center to allocate resources to perform the target delivery schedule.

2. The system of claim 1, wherein the input information includes configuration information, container information, store information, and distribution center information.

3. The system of claim 1, wherein processing the input information to determine the distribution center constraint information and the store constraint information further comprises:
analyzing the distribution center information to determine a distribution center capacity measurement; and
analyze the store constraint information to determine a store requirement measurement, the store requirement measurement including a minimum requirement value and a maximum requirement value.

4. The system of claim 3, wherein the distribution center capacity measurement includes:
determining labor capacity for each of the one or more periods of time;
determining inventory constraints of the distribution center; and
determining capping information and pull-forward information for the distribution center, wherein the capping information and the pull-forward information correspond to an ability of the distribution center to increase or decrease delivery of the one or more containers.

5. The system of claim 1, wherein validating the delivery schedule to determine the target delivery schedule for the one or more containers from the distribution center to the store during the one or more periods of time further comprises comparing the delivery schedule with capping information and pull-forward information for the distribution center to ensure the distribution center has enough resources to perform the delivery schedule.

6. The system of claim 1, further comprising:
receiving the target delivery schedule;
determining a daily schedule for the distribution center based on the target delivery schedule; and
receiving a listing of orders that have been processed.

7. The system of claim 6, further comprising:
determining if the store is a capping store, a pull forward store, or a skip store based on the daily schedule for the distribution center; and
generating an item level listing of capping items and pull forward items based on a decision ratio.

8. The system of claim 7, further comprising:
determining the store is a capping store; and
analyzing the item level listing of the capping items for the daily schedule to determine a number of items that are to be removed from the daily schedule.

9. The system of claim 7, further comprising:
determining the store is a pull forward store; and
analyzing the item level listing of the pull-forward items for the daily schedule to determine a number of items that are to be added to the daily schedule.

10. The system of claim 7, further comprising updating the target delivery schedule based on the item level listing of the capping items and the pull forward items to allocate resources to perform the target delivery schedule.

11. A method being implemented via execution of computing instructions configured to run at one or more processors and stored at one or more non-transitory computer-readable media, the method comprising:
receiving input information corresponding to allocating one or more containers for delivery from a distribution center to a store during a first time period, the one or more containers including one or more products;
processing the input information to determine distribution center constraint information and store constraint information;
generating a delivery schedule for the one or more containers from the distribution center to the store over one or more periods of time based on the distribution center constraint information and the store constraint information, wherein each of the one or more periods of time correspond to a day;
validating the delivery schedule to determine a target delivery schedule for the one or more containers from the distribution center to the store during the one or more periods of time; and
transmitting the target delivery schedule to the distribution center to enable the distribution center to allocate resources to perform the target delivery schedule.

12. The method of claim 11, wherein the input information includes configuration information, container information, store information, and distribution center information.

13. The method of claim 11, wherein processing the input information to determine the distribution center constraint information and the store constraint information further comprises:
analyzing the distribution center information to determine a distribution center capacity measurement; and
analyze the store constraint information to determine a store requirement measurement, the store requirement measurement including a minimum requirement value and a maximum requirement value.

14. The method of claim 13, wherein the distribution center capacity measurement includes:
determining labor capacity for each of the one or more periods of time;
determining inventory constraints of the distribution center; and
determining capping information and pull-forward information for the distribution center, wherein the capping information and the pull-forward information correspond to an ability of the distribution center to increase or decrease delivery of the one or more containers.

15. The method of claim 11, wherein validating the delivery schedule to determine the target delivery schedule for the one or more containers from the distribution center to the store during the one or more periods of time further comprises comparing the delivery schedule with capping information and pull-forward information for the distribution center to ensure the distribution center has enough resources to perform the delivery schedule.

16. The method of claim 11, further comprising:
receiving the target delivery schedule;
determining a daily schedule for the distribution center based on the target delivery schedule; and
receiving a listing of orders that have been processed.

17. The method of claim 16, further comprising:
determining if the store is a capping store, a pull forward store, or a skip store based on the daily schedule for the distribution center; and
generating an item level listing of capping items and pull forward items based on a decision ratio.

18. The method of claim 17, further comprising:
determining the store is a capping store; and
analyzing the item level listing of the capping items for the daily schedule to determine a number of items that are to be removed from the daily schedule.

19. The method of claim 17, further comprising:
determining the store is a pull forward store; and
analyzing the item level listing of the pull-forward items for the daily schedule to determine a number of items that are to be added to the daily schedule.

20. The method of claim 17, further comprising updating the target delivery schedule based on the item level listing of the capping items and the pull forward items to allocate resources to perform the target delivery schedule.
